(19) United States
(12) Patent Application Publication
(10) Pub. No.: US 2014/0025304 A1
(43) Pub. Date: Jan. 23, 2014

(54) INVERTED SEISMIC ATTRIBUTE QUALITY AND LOCAL ROCK PHYSICS CALIBRATION

(71) Applicant: CONOCOPHILLIPS COMPANY, Houston, TX (US)

(72) Inventors: Jason A. MCLENNAN, Anchorage, AK (US); Baishali ROY, Katy, TX (US)

(73) Assignee: CONOCOPHILLIPS COMPANY, Houston, TX (US)

(21) Appl. No.: 13/938,565

(22) Filed: Jul. 10, 2013

Related U.S. Application Data
(60) Provisional application No. 61/669,829, filed on Jul. 10, 2012.

(51) Int. Cl. G01V 1/30

(52) U.S. Cl. CPC G01V 1/30
USPC 702/14

(57) ABSTRACT

Methods and processing in the field of seismic data, particularly to more accurately predict petrophysical property variables at unsampled locations beyond and between wells.

### CROSS-REFERENCE TO RELATED APPLICATIONS

This application is a non-provisional application which claims benefit under 35 USC §119(e) to U.S. Provisional Application Ser. No. 61/669,829 filed Jul. 10, 2012, entitled “INVERTED SEISMIC ATTRIBUTE QUALITY AND LOCAL ROCK PHYSICS CALIBRATION,” which is incorporated herein in its entirety.

### STATEMENT REGARDING FEDERALLY SPONSORED RESEARCH OR DEVELOPMENT

None.

### FIELD OF THE INVENTION

The present invention relates to methods and processing in the field of seismic data, particularly to more accurately predict petrophysical property variables at unsampled locations beyond and between wells.

### BACKGROUND OF THE INVENTION

In the oil and gas industry, geophysical prospecting techniques are commonly used to aid in the search for and evaluation of subterranean hydrocarbon deposits. Generally, a seismic energy source is used to generate a seismic signal which propagates into the Earth and is at least partially reflected by subsurface reflectors (i.e., interfaces between underground formations having different acoustic impedances). The reflections are recorded by seismic detectors located at or near the surface of the Earth, in a body of water, or at known depths in the boreholes. The resulting seismic data may be processed to yield information relating to the location of the subsurface reflectors and the physical properties of the subsurface formations.

Subsurface geological modeling includes predicting key petrophysical property variables of interest such as water saturation, porosity, and permeability for development planning and production forecasting. These target variables are measured at locations where sampling tools can be run through the subsurface within wells. The geological model at these sample locations is conditioned by such measurements with little or no attached uncertainty. At unsampled locations beyond and between wells, however, the geological model requires predictions of the target variable resulting in a degree of uncertainty in those predictions.

Petrophysical properties are often related to seismic or elastic attributes such as p/s-wave velocity that can be derived from the inversion of seismic reflection data. These relationships are generally referred to as rock physics relationship and quantified with correlation coefficients derived from collocated pairs of target variables and inverted elastic attributes. To reduce prediction uncertainty and better characterize the subsurface, rock physics relationships can be honored during prediction.

Seismic inversion is the process of transforming seismic data into a quantitative rock property description of the subterranean geological formation beneath the surface of the earth. As such, seismic inversion models fundamental rock property from pre-stack or post-stack seismic data, such as acoustic impedance. These fundamental rock properties from the seismic data are used to create a description of hydrocarbon deposits in the subterranean geological formation, such as reservoirs. This description is then used to model hydrocarbon production and estimate reserves.

Inherent limitations in determining uncertainty/non-uniqueness associated with seismic inversion processes include, but are not limited to: the inability to obtain sample data at infinite resolution; the reliance of approximations in the forward model; the presence of noise related to instrumentation and environmental factors; and the inherent non-uniqueness in the rock property relations present in the geological units. However, some of these limitations can be minimized by: careful processing of the seismic field data such that it meets the assumptions of the forward modeling operator; careful parameterization of the inverse problem that gives best discrimination or detectibility; constraining the inverse problem with both physical and rock physics correlation bounds (prior constraints); and assuming a starting model of the parameters of interest for easier convergence to a solution. Nevertheless, differences between the observed data and predicted data, called data misfit, may still exist. The misfit between the starting model and the final model is termed as the model misfit or model norm. The inverse problem is usually solved by iterative optimization methods such as iterative least squares (Lawson and Hanson, 1974) or conjugate gradient methods that are well know in the numerical computation literature or through Global optimization methods such as Simulated Annealing or Markov Chain Monte Carlo methods (Sen and Stoffa, 1991, 1996; Stoffa and Sen, 1991; Runinstein, 1981; Davis and Principe, 1993)), which are more based on random searches through the model space that provides the global minimum solution. The misfit functions can be used as diagnostics of the quality of the inversion and the quality of the seismic data. This measure of quality can be utilized as key information while geologic model building using a seismically driven earth model. Seismic inversion algorithms can be both deterministic (meaning the solution gives the most likelihood solution) or stochastic (meaning the solution can give a range of equally probable results all satisfying the objective function). The most important information from a seismic inversion is a 3D volumetric distribution of earth elastic properties (within the limits of seismic detectibility and noise) which can be related to reservoir properties through rock physics relations as referred in the next section.

Rock physics relationships may be accounted for in the practice of geological modeling by applying geostatistical algorithms and techniques (Journel and Huijbregts, 1978). The simple cokriging, an extension of the simple kriging formalism, is a technique to handle multiple attribute correlations simultaneously; however, the technique posed difficulty in inferring a positive definite linear model of coregionalization. The Markov screening assumption technique for retaining only attribute data collocated to the target variable requires only the correlation coefficient between the attribute and target variable (Xu et al., 1992), but only one attribute can be used at a time. Bayesian Updating allows prediction of variables based on combining attributes into a likelihood and merging them with a prior model of the target variable. The combination of attributes is done according to correlation coefficient derived from collocated pairs of the target variable and secondary attributes like inverted elastic properties from seismic reflection data.

The quantification of rock physics relationships with correlation coefficients derived from collocated pairs of petrophysical and inverted elastic attribute data is in itself deficient. Without modification, these calculated correlation coefficients assume that the paired petrophysical properties and inverted elastic attributes are of equal quality and reliability. This is not the case since petrophysical properties are more directly measured while elastic attributes are the result of imperfectly matching the seismic reflection data and a parametric model for this reflection data during the inversion process. This deficiency results in an overestimation of the absolute value correlation and artificially allows inverted elastic attributes too much influence on prediction in turn making the prediction uncertainty optimistically too low. The quality of an inverted elastic attribute should be accounted for by modifying the rock physics relationship calibrating it to petrophysical property prediction.

The quality of an inverted elastic attribute depends on how well it balances the fit to seismic reflection data and the input parametric model for this reflection data. Since this fit changes on a local basis, there is a need to develop a method of defining a locally varying inverted elastic attribute quality factor for modifying the rock physics calibration to target petrophysical properties.

### SUMMARY OF THE INVENTION

In an embodiment, a method of seismic data processing includes: (a) acquiring a pre-stack seismic data survey that covers a volume, wherein the pre-stack seismic data survey is acquired using a plurality of sensors adapted to sense seismic energy, wherein the pre-stack seismic data survey represents subterranean characteristics within a subterranean region; (b) performing an inversion of the pre-stack seismic data survey to determine rock elastic property relationships for each of a plurality of positions within the volume, wherein during inversion of the pre-stack reflection data a model misfit (φₘ) and a data misfit (φ_{d}) are determined; and (c) calculating a seismic attribute quality (SAQ) for each of the plurality of positions within the volume, wherein the seismic attribute is representable as:

SAQ=1−(φ_{d}+φₘ)

or any mathematical equivalents thereof.

In another embodiment, a method of seismic data processing includes: acquiring pre-stack seismic data survey that covers a volume, wherein the pre-stack seismic data survey is acquired using a plurality of sensors adapted to sense seismic energy, wherein the pre-stack seismic data survey represents subterranean characteristics within a subterranean region; (b) performing an inversion of the pre-stack seismic data survey to determine rock elastic property relationships for each of a plurality of positions within the volume, wherein during inversion of the pre-stack reflection data a model misfit (φₘ) and a data misfit (φ_{d}) are determined; (b) calculating a seismic attribute quality (SAQ) for each of the plurality of positions within the volume, wherein the seismic attribute is representable as:

SAQ=1−(φ_{d}+φₘ)

or any mathematical equivalents thereof; determining a new rock physical relationship (ρ_{L},), wherein the new rock physical relationship (ρ_{L}) is representable as:

ρ_{L}=SAQ·ρ

or any mathematical equivalents thereof, where (ρ) is a global correlation coefficient; and (e) applying the new rock physical relationship to the pre-stack seismic data survey.

### BRIEF DESCRIPTION OF THE DRAWINGS

The invention, together with further advantages thereof, may best be understood by reference to the following description taken in conjunction with the accompanying drawings in which:

FIG. 1 is a flow chart of the basic steps in some embodiment of the present invention.

FIGS. 2A-2D show application of the present invention as described in the Example.

FIGS. 3A-3F show application of the present invention as described in the Example.

FIGS. 4A-4H show application of the present invention as described in the Example.

### DETAILED DESCRIPTION OF THE INVENTION

Reference will now be made in detail to embodiments of the present invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the appended claims and their equivalents.

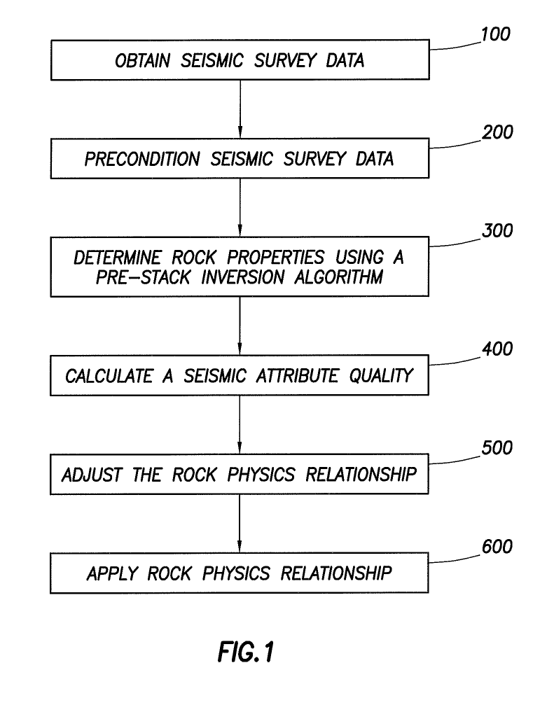

A flowchart of steps that may be utilized by embodiments of the present invention illustrated in FIG. 1. Some of the blocks of the flow chart may represent a code segment or other portion of the compute program. In some alternative implementations, the functions noted in the various blocks may occur out of the order depicted in FIG. 1. For example, two blocks shown in succession in FIG. 1 may in fact be executed substantially concurrently, or the blocks may sometimes be executed in the reverse order depending upon the functionality involved.

In step 100, seismic survey data is obtained.

In step 200, the seismic survey data is processed to produce an image of the subsurface and necessary pre-stack data required for inversion. After processing/imaging, the pre-stack data often needs further pre-conditioning to comply with the assumptions of the forward modeling operator in the seismic inversion. In the event preconditioning is a necessary step, the pre-stack seismic data used will have any necessary pre-conditioning processing applied prior to inversion. For example, the seismic survey data may contain “multiples” which should be removed prior to inversion. Multiples are events or arrivals of seismic energy that have been reflected more than once. Processing techniques for the removal of other noise types, unwanted energy and interference are well known in the art.

In step 300, elastic rock properties are determined using a pre-stack inversion algorithm. Pre-stack inversion algorithms are known in the art to simultaneously produce elastic properties like P-impedance, S-impedance and density followed by rock physics transforms to produce lithology cubes. AVO (AVA) geostatistical inversion incorporates both elastic properties in the seismic resolution and higher resolution properties from well log measurements into a single method. The output models (realizations) are consistent with well log information, AVO seismic data, and honor rock property relationships found in the wells. Because all output models are equi-probable models satisfying the data constraints, the uncertainty can be quantitatively assessed to determine the range of reservoir possibilities within the constraining data.

While any pre-stack inversion algorithm may be utilized, for explanatory purposes the pres-tack inversion algorithm presented in U.S. Pat. No. 7,072,767 entitled “Simultaneous Inversion for Source Wavelet and AVO Parameters from Prestack Seismic Data” is utilized. The inversion algorithm is formulated as:

minφₘ=αₛ∫(S(t)−S_{ref}(t))²dt+αₐ∫|a(t₀)−a_{ref}(t₀)|dt₀+α_{b}∫|b(t₀)−b_{ref}(t₀)|dt₀+α_{c}∫|c(t₀)−c_{ref}(t₀)|dt₀

subject to φ_{d}=||W_{d}(d^{obs}−F(a,b,c,S))||²−φ_{d}^{*}
subject to a^{min}≦a≦a^{max}
subject to b^{min}≦b≦b^{max}
subject to c^{min}≦c≦c^{max}
subject to −1≦r(a,b,c)≦1
   where,
   φₘ=the model misfit function;
   φ_{d}=the data misfit function;
   S(t)=the source function to be obtained from inversion;
   S_{ref}(t)=the reference model for source function, which can be any a priori model, including a null set;
   φ_{S}, αₐ, α_{b}, α_{c}=the control parameters (scalar) that control the relative contribution of the source, intercept and gradient norms;
   a=a(t₀),b=b(t₀),c=c(t₀);
   a_{ref}(t₀)=the reference intercept model at zero offset time t₀;
   b_{ref}(t₀)=the reference gradient model at zero offset time t₀;
   c_{ref}(t₀)=the reference curvature model at zero offset time t₀;
   W_{d}=a data weighting matrix, essentially a diagonal matrix whose elements are the reciprocal of the standard deviation for each datum;
   d^{obs}=a vector containing the data;
   F(a, b, c, S)=the forward modeling operator to generate the predicted data;
   φ_{d}^{*}=the final data misfit to be achieved after the inversion;
   a^{min}, a^{max}, b^{min}, b^{max}, c^{min}, c^{max}=the lower and upper bounds of the AVO parameters; and
   r(a, b, c, θ)=the P-wave reflection coefficient as a function of AVO parameters and the angle of incidence θ.

In step 400, a seismic attribute quality is calculated. Elastic attributes derived from seismic inversion are obtained using an optimization procedure. The optimization provides a balance between consistency with the seismic reflection data, i.e., adequately fitting the geophysical data, and consistency with a prior geological model input. The seismic attribute quality (SAQ) accounts for both data misfit and model norm, defined as:

SAQ=1−(φ_{d}+φₘ)

subject to φ_{d}=||W_{d}(d^{obs}−F(a, b, c, S))||²=φ_{d}^{*}
subject to mod el misfit=(φₘ=β(m−m_{ref})^{T}R^{T}W^{T}[Cₘ⁻¹]WR(m−m_{ref})
where,
β=the regularization parameter that controls the relative weighting of the model norm and data misfit;
m=the model parameter to be inverted;
m_{ref}=the reference model parameter (prior model);
T=transpose operator;
R=r(a,b,c,θ);
W=weighting matrix;
Cₘ=the model covariance matrix; and
F(m, s)=forward modeling operator same i.e., convolution of r(a,b,c,θ) and source function.

The data misfit term measures the degree to which the inverted seismic attribute quality (SAQ)satisfies the reflection data in the pre-stack domain. In regions where imaging is more difficult due to data coverage or otherwise, the data misfit term will increase and the seismic attribute quality (SAQ) will decrease.

In addition to fitting the data, the pre-stack inversion algorithm also strives for consistency with any input from a prior geological model. The prior geological model misfit is referred to as the mod el misfit or the as the model norm. The mod el misfit is expressed as a product of a regularization parameter (β) with the norm of the inverted models departure from the prior model. Large departures from the prior model increases the model misfit term and thus decreased the SAQ.

Low seismic attribute quality (SAQ) is a balance between the data misfit and the model misfit . For example, large departures from the prior (larger model misfit) usually imply the seismic attribute quality (SAQ) had to adapt more to the reflection data (smaller data misfit). Therefore, the regularization parameter plays a crucial role in balancing the data misfit and the model misfit .

In step 500, the rock physics relationship is adjusted. The seismic attribute quality (SAQ) can be computed at every gather location, standardized by its maximum to lie between 0 to 1 (best quality approaches unity), and then used to locally adjust the rock physics relationship as follows:

ρ_{L}=SAQ_{L}·ρ

where,
ρ=the global correlation coefficient derived from collocated pairs of the target variable and the inverted seismic attribute representing the global rock physics relationship;
SAQ_{L}=the local inverted seismic attribute quality; and
ρ_{L}=the local correlation coefficient representing the new local rock physics relationship.

This new rock physic relationship can be honored during prediction of the primary variable using geostatistical techniques such as collocated cokriging and Bayesian Updating. The implementation of the new rock physics relationship is similar to Bayesian Updating, except the influence of the secondary inverted attribute are scaled back locally according to the SAQ .

In step 600, the new rock physics relationship is applied.

In closing, it should be noted that the discussion of any reference is not an admission that it is prior art to the present invention, especially any reference that may have a publication date after the priority date of this application. At the same time, each and every claim below is hereby incorporated into this detailed description or specification as a additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

### EXAMPLE

The present inventive method was applied to actual seismic data acquired over a potential oil field. After the seismic data was acquired, the following pre-stack inversion algorithm described in Roth et al. (U.S. Pat. No. 7,072,767) was utilized:

min φₘ=α_{S}∫(S(t)−S_{ref}(t))²dt+αₐ∫|a(t₀)−a_{ref}(t₀)|dt₀+α_{b}∫|b(t₀)−b_{ref}(t₀)|dt₀+α_{c}∫|c(t₀)−c_{ref}(t₀)|dt₀

subject to φ_{d}=||W_{d}(d^{obs}−F(a,b,c,S))||²−φ_{d}^{*}
subject to a^{min}≦a≦a^{max}
subject to c^{min}≦c≦c^{max}
subject to −1≦r(a,b,c)≦1
   where,
   φₘ=the model misfit function;
   φ_{d}=the data misfit function;
   S(t)=the source function to be obtained from inversion;
   S_{ref}(t)=the reference model for source function, which can be any a priori model, including a null set;
   α_{S}, αₐ, α_{b}, α_{c}=the control parameters (scalar) that control the relative contribution of the source, intercept and gradient norms;
   a=a(t₀),b=b(t₀),c=c(t₀);
   a_{ref}(t₀)=the reference intercept model at zero offset time t₀;
   b_{ref}(t₀)=the reference gradient model at zero offset time t₀;
   c_{ref}(t₀)=the reference curvature model at zero offset time t₀;
   W_{d}=a data weighting matrix, essentially a diagonal matrix whose elements are the reciprocal of the standard deviation for each datum;
   d^{obs}=a vector containing the data;
   F(a, b, c, S)=the forward modeling operator to generate the predicted data;
   φ_{d}^{*}=the final data misfit to be achieved after the inversion;
   a^{min}, a^{max}, b^{min}, b^{max}, c^{min}, c^{max}=the lower and upper bounds of the AVO parameters; and
   r(a,b,c,θ)=the P-wave reflection coefficient as a function of AVO parameters and the angle of incidence θ.

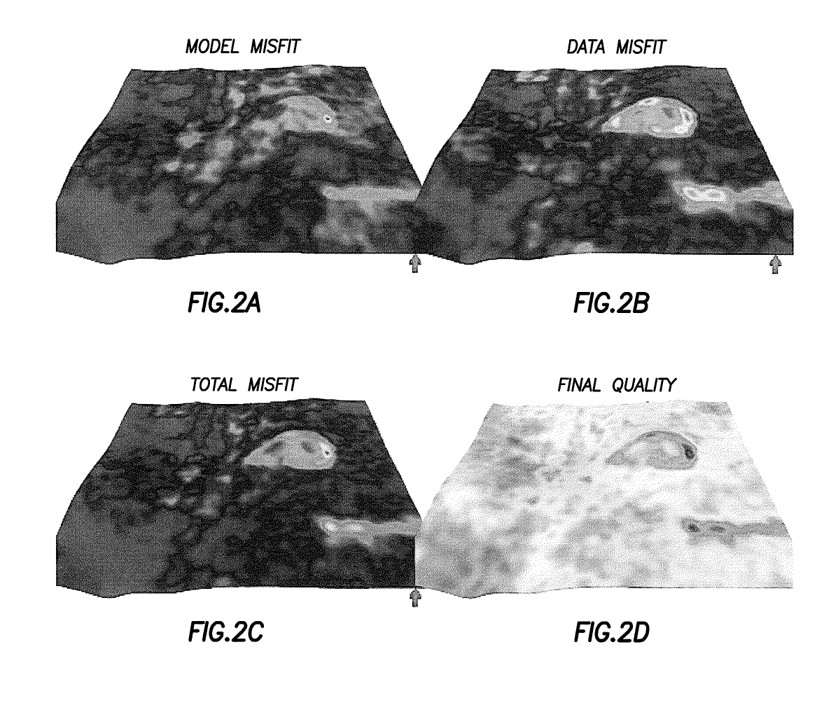

The model misfit, shown in FIG. 2a, was determined by utilizing the following relationship:

φₘ=β(m−m_{ref})^{T}R^{R}W^{T}[C_{ref}⁻¹]WR(m−m_{ref})

The data misfit, shown in FIG. 2b, was determined by utilizing the following relationship:

φ_{d}=||W_{d}(d^{abs}−F(m, s))||²

The total misfit, shown in FIG. 2c, was determined by utilizing the following relationship:

φ=φₘ+φ_{d}

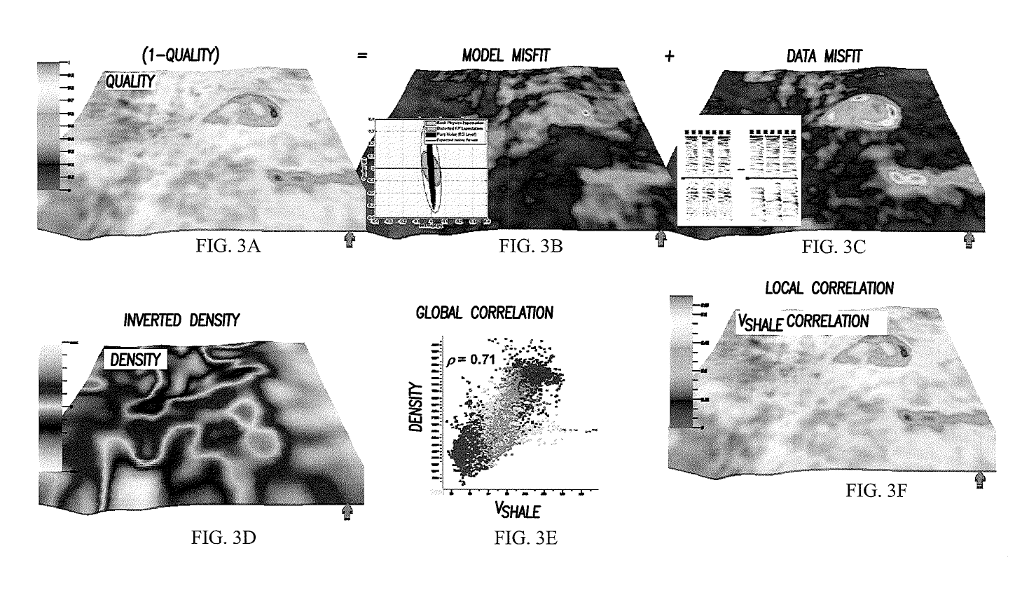

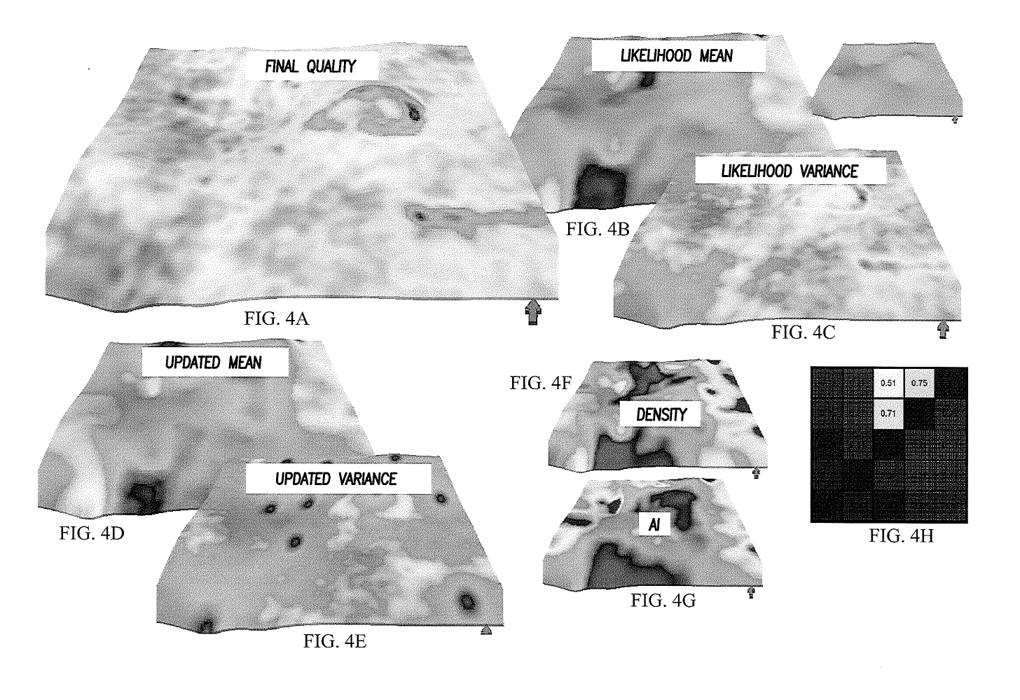

FIG. 2D shows the final quality. The seismic attribute quality, shown in FIGS. 3A-3F and 4A-4H, was determined by utilizing the following relationship:

SAQ=1−φ

As shown in the model, data and total misfit (FIGS. 3A-3F and 4A-4H), prediction uncertainty exists. The seismic attribute quality provides a more accurate prediction, by reducing the uncertainty as.

### REFERENCES

All of the references cited herein are expressly incorporated by reference. The discussion of any reference is not an admission that it is prior art to the present invention, especially any reference that may have a publication data after the priority date of this application. Incorporated references are listed again here for convenience:

### 1. Journal and Huijbregts, Mining Geostatistics, Academic Press, New York (1978).

2. Xu, et al., “Integration Seismic Data in Reservoir Modeling: The Collocated Cokriging Alternative,” Soc. Petro. Eng., Paper 24742 (1992).
3. Davis , T. E., and J. C. Principe, 1993, A Markov Chain Framework for the simple genetic algorithm: Evolutionary Computation, 1, 269-288
4. Lawson, C. L., and R. J., Hanson, 1974, Solving Least Squares Problems; Prentice hall Inc.

### 5. Parker, R, L.;1994, Geophysical Inverse Theory, Princeton University Press

### 6. Menke, W., 1989. Geophysical Data Analysis, Academic Press

7. Rubinstein, R. Y., 1981, Simulation and Monte Carlo method: John Wiley and Sons Inc
8. Sen, M. K., and P. L. Stoffa, 1991, Non-linear one-dimensional seismic waveform inversion using simulated annealing, Geophysics, 56, 1624-1638
9. Sen, M. K., and P. L. Stoffa, 1996, Bayesian inference, Gibb's sampler and uncertainty estimation in geophysical inversion, Geophysical Prospecting, 44, 313-350
10. Stoffa, P. L., and M. K. Sen, 1996, Non-linear multiparameter optimization using genetic algorithm: Inversion of plane wave seismograms, Geophysics, 56, 1794-1810.

### 11. Foust “Surmont Pilot History Matching—Incorporation of 4D Seismic,” Subsurface Conference 2007 Full Posters

11. Tarantola, A.; 1987; Inverse Problem Theory: Methods for data fitting and model parameter estimation: Elsevier Science Publishing Co. Inc.

1. A method of seismic data processing comprising:
a. acquiring a pre-stack seismic data survey that covers a volume, wherein the pre-stack seismic data survey is acquired using a plurality of sensors adapted to sense seismic energy, wherein the pre-stack seismic data survey represents subterranean characteristics within a subterranean region;
b. performing an inversion of the pre-stack seismic data survey to determine rock elastic property relationships for each of a plurality of positions within the volume, wherein during inversion of the pre-stack reflection data a model misfit (φₘ) and a data misfit (φ_{d}) are determined; and
c. calculating a seismic attribute quality (SAQ) for each of the plurality of positions within the volume, wherein the seismic attribute is representable as:
SAQ=1−(φ_{d}+φₘ)
or any mathematical equivalents thereof.

2. A method of seismic data processing comprising:
a. acquiring pre-stack seismic data survey that covers a volume, wherein the pre-stack seismic data survey is acquired using a plurality of sensors adapted to sense seismic energy, wherein the pre-stack seismic data survey represents subterranean characteristics within a subterranean region;
b. performing an inversion of the pre-stack seismic data survey to determine rock elastic property relationships for each of a plurality of positions within the volume, wherein during inversion of the pre-stack reflection data a model misfit (φₘ) and a data misfit (φ_{d}) are determined;
c. calculating a seismic attribute quality (SAQ) for each of the plurality of positions within the volume, wherein the seismic attribute is representable as:
SAQ=1−(φ_{d}+φₘ)
or any mathematical equivalents thereof;
d. determining a new rock physical relationship (ρ_{L}), wherein the new rock physical relationship (ρ_{L}) is representable as:
ρ_{L}=SAQ−ρ
or any mathematical equivalents thereof, where (ρ) is a global correlation coefficient; and
e. applying the new rock physical relationship to the pre-stack seismic data survey.
